(19) United States
(12) Patent Application Publication
(10) Pub. No.: US 2010/0002763 A1
(43) Pub. Date: Jan. 7, 2010

(54) APPARATUS AND METHOD FOR DIGITAL ITEM DESCRIPTION AND PROCESS USING SCENE REPRESENTATION LANGUAGE

(76) Inventors: Ye-Sun Joung, Daejon (KR); Jung-Won Kang, Seoul (KR); Won-Sik Cheong, Daejon (KR); Ji-Hun Cha, Daejon (KR); Kyung-Ae Moon, Daejon (KR); Jin-Woo Hong, Daejon (KR); Young-Kwon Lim, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 12/442,539

(22) PCT Filed: Sep. 21, 2007
(86) PCT No.: PCT/KR07/04693

§ 371 Date: Mar. 24, 2009

(30) Foreign Application Priority Data
Sep. 25, 2006 (KR) 10-2006-0092906

(51) Int. Cl. H04N 11/04

(52) U.S. Cl. 375/240.01; 375/E07.001

(57) ABSTRACT

Provided are an apparatus and method for describing and processing digital items using a scene representation language. The apparatus includes a digital item method engine (DIME) unit for executing components based on component information included in the digital item; and a scene representation unit for expressing scenes of a plural number of media data included in the digital item in a form of defining spatio-temporal relations and allowing the media data to interact with each other. The digital item includes scene representation having representation information of the scene, and calling information for the digital item express unit to execute the scene representation unit in order to represent the scene based on the scene representation information at the scene representation unit.

### TECHNICAL FIELD

The present invention relates to an apparatus and method for describing and processing digital items using a scene representation language; and, more particularly, to an apparatus for describing and processing digital items, which defines spatio-temporal relations of MPEG-21 digital items and express multimedia contents scenes in a form that allows the MPEG-21 digital items to interact with each others, and a method thereof.

This work was supported by IT R & D program of MIC/IITA [2005-S-015-02, “Development of interactive multimedia service technology for terrestrial DMB (digital multimedia broadcasting)”].

### BACKGROUND ART

Moving Picture Experts Group 21 (MPEG-21) is a multimedia framework standard for using various layers of multimedia resources in generation, transaction, transmission, management, and consumption of digital multimedia contents.

The MPEG-21 standard enables various networks and apparatuses to transparently and expendably use multimedia resources. The MPEG-21 standard includes several stand-alone parts that can be used independently. The stand-alone parts of the MPEG-21 standard includes Digital Item Declaration (DID), Digital Item Identification (DII), Intellectual Property Management and Protection (IPMP), Right Expression Language (REL), Right Data Dictionary (RDD), Digital Item Adaptation (DIA), and Digital Item Processing (DIP).

A basic processing unit of a MPEG-21 framework is digital item (DI). The DI is generated by packaging resources with an identifier, metadata, a license, and an interaction method.

The most important concept of the DI is the separation of static declaration information and processing information. For example, a hypertext markup language (HTML) based webpage includes only static declaration information such as a simple structure, resources, and metadata information, and a script language such as JAVA and ECMA includes processing information. Therefore, the DI has an advantage of allowing a plurality of users to obtain different expressions of the same digital item declaration (DID) That is, it is not necessary for a user to instruct how information is processed.

For the declaration of DI, the DID provides an integrated and flexible concept and an interactive schema. The DI is declared by a digital item declaration language (DIDL).

The DIDL is used to create a digital item that is mutually compatible with an extensible markup language (XML). Therefore, the DI declared by the DIDL is expressed as a text format while generating, supplying, transacting, authenticating, occupying, managing, protecting, and using multimedia contents.

FIG. 1 is a diagram illustrating DID sentences that express a digital item using a digital item declaration language (DIDL) according to MPEG-21 standard, and FIG. 2 is a block diagram illustrating the DIDL structure of FIG. 1.

As shown in FIGS. 1 and 2, two items 101 and 103 are declared in the shown DID sentences. The first item 101 includes two selections of 300 Mbps and 900 Mbps. The second item 103 has two components, 111 and 113. The first component 111 includes one main video, main.wmv, and the second component 113 includes two auxiliary videos, 300_video.wmv and 900_video.wmv, each having the conditions of 300 Mbps and 900 Mbs respectively.

The digital item processing (DIP) provides a mechanism for processing information included in a DI through a standardized process and defines the standards of a program language and library for processing a DI declared by a DIDL. MPEG-21 DIP standard enables a DI author to describe an intended process of the DI.

The major item of the DIP is a digital item method (DIM). The digital item method (DIM) is a tool for expressing the intended interaction between a MPEG-21 user and a digital item at a digital item declaration (DID) level. The DIM includes a digital item base operation (DIBO) and DIDL codes.

FIG. 3 is a block diagram illustrating a MPEG-21 based DI processing system according to the related art.

As shown in FIG. 3, the MPEG-21 based DI processing system according to the related art includes a DI input means 301, a DI processor means 303, and a DI output means 305. The DI processor means 303 includes a DI process engine unit 307, a DI express unit 309, and a DI base operation unit 311.

The DI process engine unit 307 may include various DI process engines. For example, the DI process engine may include a DID engine, a REL engine, an IPMP engine, a DIA engine, etc.

The DI express unit 309 may be a DIM engine (DIME), and the DI base operation unit 311 may be a DIBO.

A DI including a plurality of digital item methods (DIM) is inputted through the DI input means 301. The DI process engine unit 307 parses the inputted DI. The parsed DI is inputted to the DI express unit 309.

Here, the DIM is information that defines the operations of the DI express unit 309 to process information included in a DI. That is the DIM includes information about a process method and an identification method included in the DI.

After receiving the DI from the DI process engine unit 307, the DI express unit 309 analyzes a DIM included in the DI. The DI express unit 309 interacts with various DI process engines included in the DI process engine 307 using the analyzed DIM and a DI base operation function included in the DI base operation unit 311. As a result, each of the items included in the DI is executed, and the executing results are outputted through the DI output means 305.

Meanwhile, a scene representation language defines spatio-temporal relations of media data and expresses the scenes of multimedia contents. Such scene representation languages include synchronized multimedia integration language (SMIL), scalable vector graphics (SVG), extensible MPEG-4 textual format (XMT), and lightweight applications scene representation (LASeR).

MPEG-4 Part 20 is a standard for representing and providing a rich media service to a mobile device having limited resources. The MPEG-4 part 20 defines a LASeR and a simple aggregation format (SAF).

LASeR is a binary format for encoding the contents of a rich media service, and SAF is a binary format for multiplexing a LASeR stream and associated media streams to a single stream.

Since the LASeR standard is for providing a rich media service to a device with limited resources, the LASeR standard defines a graphic, an image, a text, the spatio-temporal relations of audio object and visual object, interactions, and animations.

For example, media data, which is expressed by a scene representation language such as LASeR, can represent various spatio-temporal scene representations.

However, it is impossible to represent a scene with a spatio-temporal relation if multimedia contents are formed by integrating various media resources because MPEG-21 framework does not support a scene representation language including the temporal and the spatial arrangement information of scenes.

According to the MPEG-21 standard, scene representation information is not included in a digital item (DI), and a DIP does not define scene representation although the DIP defines digital item processing. Therefore, each of the terminals that consume digital items has the different visual configuration of components like that the same HTML page is differently shown at different browsers. That is, the current MPEG-21 framework has a problem the digital items cannot be provided to a user through the consistent method.

FIG. 4 is a picture illustrating a scene outputted according to scene representation with a spatio-temporal relation.

For example, the author of a DI wants an auxiliary video 403 to be located at the left lower corner of a scene for optimizing the spatial arrangement of two videos as contents including a main video 401 and an auxiliary video 403. Also, a corresponding author wants to create contents to be played the auxiliary video 403 at a predetermined time after the main video 401 is played for balancing a temporal balance of contexts.

However, it is impossible to define the spatio-temporal configuration of components with the current DID specification and DIP specification of MPEG-21 standard. In MPEG-21 standard, the DIP related DIBOs include alert( ), execute( ), getExternalData( ), getObjectMap( ), getobjects( ), getvalues( ), play( ), print( ), release( ), runDIM ( ), and wait( ). However, the DIP related DIBO does not include a function for extracting scene representation information from DID.

FIG. 5 is a diagram illustrating two LASeR structures as examples of scene representation language structures corresponding to the DIDL structure of FIG. 2.

According to the MPEG-21 standard, a digital item (DI) is expressed by the DIDL, and the main components of the DIDL are Container, Item, Descriptor, Component, Resource, Condition, choice, and selection. The Container, Item, and Component, which perform a grouping process, are equivalent to the <g> component of the LASeR. The Resource component of the DIDL defines an individually identifiable item, and each of the Resource components includes a MIME type property and a ref property for specifying a data type and a uniform resource identifier (URI) of the item. Since each Resource is identified as audio, video, text, and image, they correspond to <audio>, <video>, <text>, and <image> components of LASeR respectively. The ref property of Resource may equivalent to xlink:href of LASeR. Also, elements for processing conditions or an interaction method in LASeR include <conditional>, <listener>, <switch>, and <set>. The <switch> is equivalent to Condition, Choice, and Selection of the DIDL. The <desc> of LASeR is equivalent to Descriptor of DIDL.

FIG. 5 illustrates two LASeR structures corresponding to the DIDL structure of FIG. 2. That is, FIG. 5 shows the LASeR structure 501 where a system determines whether the auxiliary video is expressed at 300 Mbps or 900 Mbps and the LASeR structure 502 where a user determines whether the auxiliary video is expressed at 300 Mbps or 900 Mbps. In FIG. 5, elements in the LASeR structures 501 and 503 are mapped to corresponding elements in the DIDL structure through arrows.

As shown in FIG. 5, a DIDL structure may correspond to a plural number of the LASeR structures 501 and 503. Therefore, a scene may be differently presented according to the environment of a terminal although the scene has the same DIDL structure, and thus a scene may not be represented according to the intention of a DI author.

Therefore, there has been a demand for developing a method for providing a consistent DI consuming environment by including scene representation information in DIDL.

FIGS. 6 and 7 are diagrams illustrating exemplary scene description sentences for presenting LASeR structures of FIG. 5. FIG. 6 shows scene description sentences that present the LASeR structure 501 where a system decides whether the auxiliary video is expressed at 300 Mbps or 900 Mbps, and FIG. 7 shows scene description sentences that express the LASeR structure 503 where a user decides whether the auxiliary video is expressed at 300 Mbps or 900 Mbps.

The scene description sentences in FIG. 6 define the start points of a main video and an auxiliary video and a bit rate of the auxiliary video, for example, 300 Mbps or 900 Mbps.

The scene description sentences of FIG. 7 define the start points of a main video and an auxiliary video, the bit rate 300 Mbps or 900 Mbps of an auxiliary video, and a scene size according to each of the bit rates.

FIGS. 8 and 9 are diagrams illustrating a LASeR scene outputted according to the scene description sentences shown in FIG. 7. FIG. 8 is a scene that allows a user to select a bit rate of an auxiliary video using a selection menu 803 that is displayed while the main video 801 is outputted. FIG. 9 is a scene where the selected auxiliary video 901 is outputted while the main video 801 is outputted.

As described above, the components of the DIDL structure in the current MPEG-21 standard are partially equivalent to the components of a scene representation which define the spatio-temporal relations of media components and present a scene of multimedia contents in a form that allows the components to interact with each others. However, the scene representation information is not included in a digital item according to MPEG-21 standard. Also, the DIP does not define a scene representation but defines digital item processing. Therefore, the MPEG-21 framework has problems that the MPEG-21 framework cannot define a digital item (DI) with the spatio-temporal relation of media components through a clear and consistent method and cannot express a scene of multimedia contents in a form that allow digital items to interact with each others.

Such a problem is caused because the characteristics of the MPEG-21 standard are not matched with that of the scene representation. For example, the LASeR is a standard for representing a rich media scene that specifies the spatio-temporal relation of media. On the contrary, the DI of the MPEG-21 standard is for static declaration information. That is, the scene representation of a DI is not defined in the MPEG-21 standard.

### DISCLOSURE

Technical Problem

An embodiment of the present invention is directed to providing an apparatus and method for describing and processing digital items (DI), which define the spatio-temporal relation of MPEG-21 digital items and express a scene of multimedia contents in a form that allows the MPEG-21 digital items to interact.

Technical Solution

In accordance with an aspect of the present invention, there is provided a digital item processing apparatus for processing a digital item expressed as a digital item declaration language (DIDL) of MPEG-21, including: a digital item method engine (DIME) means for executing components based on component information included in the digital item; and a scene representation means for expressing scenes of a plural of media data included in the digital item in a form that defines a spatio-temporal relation and allows the media data to interact, wherein the digital item includes scene representation information having representation information of the scene; and a digital item processing means including the calling information for the digital item processing means to execute the abovementioned scene representation means based on the scene representation information at the scene representation means.

In accordance with another aspect of the present invention, there is provided a digital item processing apparatus for processing a digital item, including: a digital item express means for executing components based on component information included in the digital item; and a scene representation means for expressing a scene of a plural of media data included in the digital item a form that defines a spatio-temporal relation and allows the media data to interact, Wherein the digital item includes scene representation information including the representation information of the scene; and a digital item processing means including the calling information for executing the abovementioned scene representation means by the digital item express means for expressing the scene based on the scene representation information at the scene representation means.

In accordance with another aspect of the present invention, there is provided a method for processing a digital item described as a digital item declaration language (DIDL) of a MPEG-21 standard, including the steps of: executing components based on component information is included in the digital item by digital item method engine (DIME); and expressing a scene of a plural of media data included in the digital item in a form that defines a spatio-temporal relation and allows the media data to interact, wherein the digital item includes scene representation information having representation information of the scene; and a digital item processing means including the calling information to perform the step of expressing the scene of a plural number of media data in order to express the scene based on the scene representation information.

In accordance with another aspect of the present invention, there is provided a method for processing a digital item, including the steps of: executing components based on component information included in the digital item; and expressing a scene of a plural of media data included in the digital item a form that defines a spatio-temporal relation and allows the media data to interact, wherein the digital item includes scene representation information having representation information of the scene; and a digital item processing means including the calling information to perform the step of expressing the abovementioned scene of a plural number of media data in order to express the scene based on the scene representation information.

### ADVANTAGEOUS EFFECTS

An apparatus and method for describing and processing a digital item using a scene representation language according to the present invention can define a spatio-temporal relation of MPEG-21 digital items and express a scene of multimedia contents in a form that allows the MPEG-21 digital items to interact if multimedia contents are formed by integrating various media resources of a MPEG-21 digital item.

### BRIEF DESCRIPTION OF THE DRAWINGS

FIG. 1 is a diagram illustrating DID sentences that express a digital item using a digital item declaration language (DIDL) according to MPEG-21 standard.

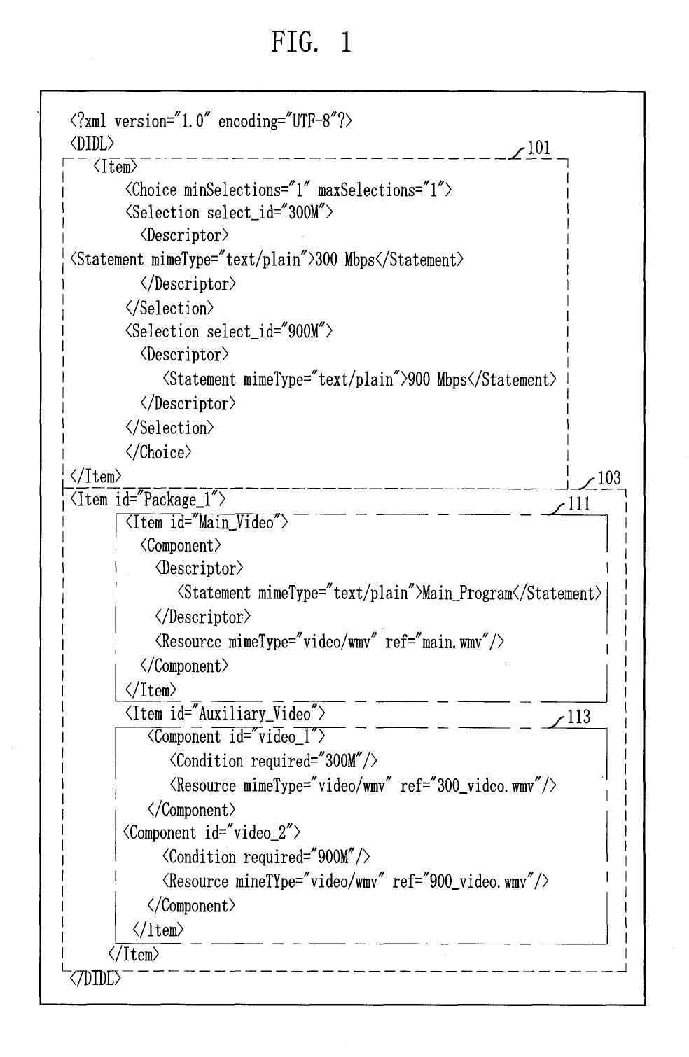

FIG. 2 is a block diagram illustrating the DIDL structure of FIG. 1.

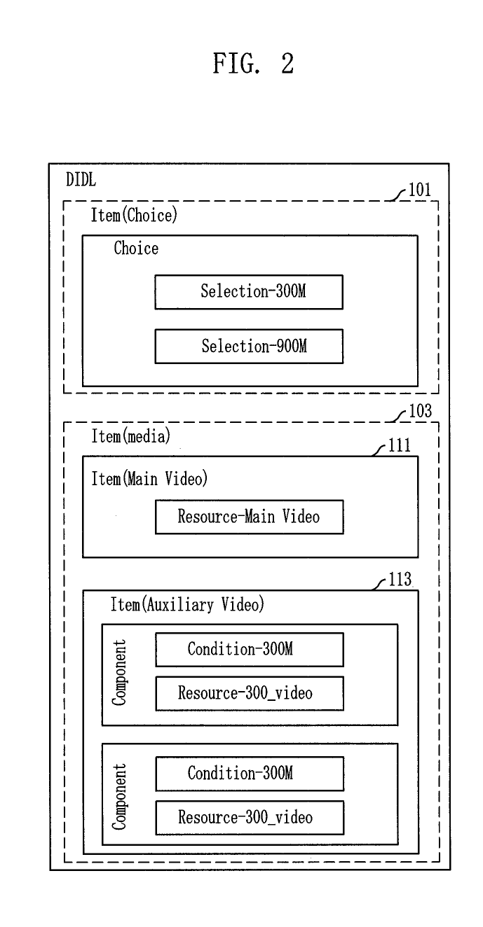

FIG. 3 is a block diagram illustrating a MPEG-21 based DI processing system according to the related art.

FIG. 4 is a picture illustrating a scene outputted according to scene representation with a spatio-temporal relation.

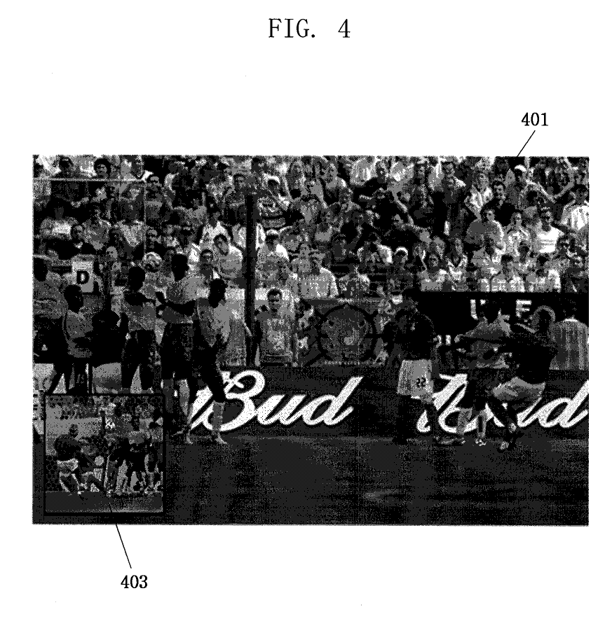

FIG. 5 is a diagram illustrating two LASeR structures as examples of scene representation structures corresponding to the DIDL structure of FIG. 2.

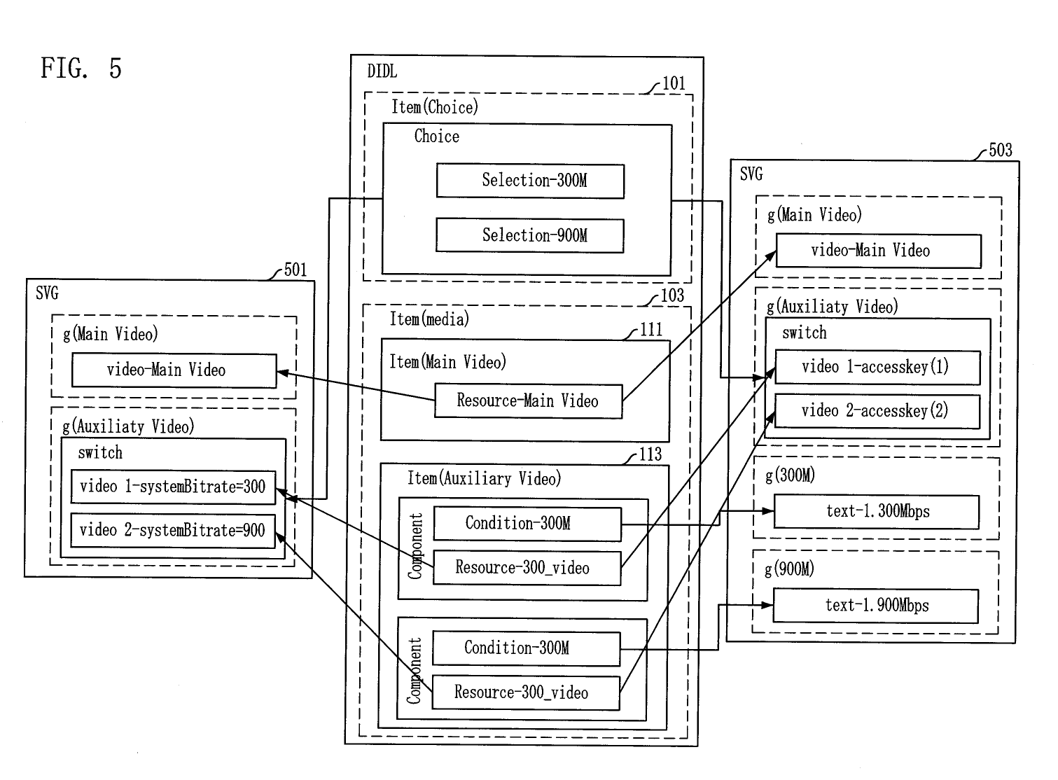

FIG. 6 is a diagram illustrating exemplary scene description sentences for expressing a LASeR structure of FIG. 5.

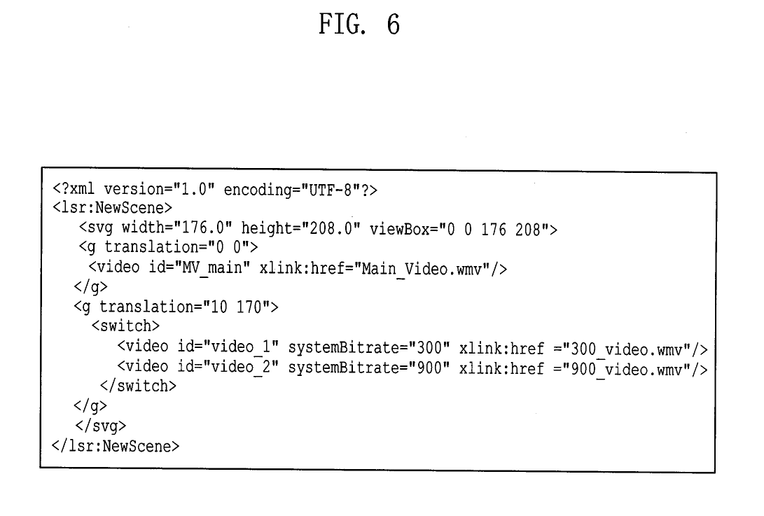

FIG. 7 is a diagram illustrating exemplary scene description sentences for expressing a LASeR structure of FIG. 5.

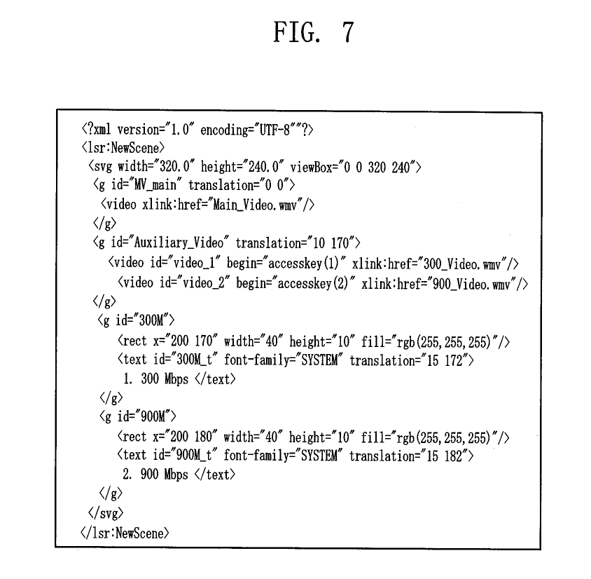

FIG. 8 is a diagram illustrating a LASeR scene description scene outputted according to the sentences shown in FIG. 7.

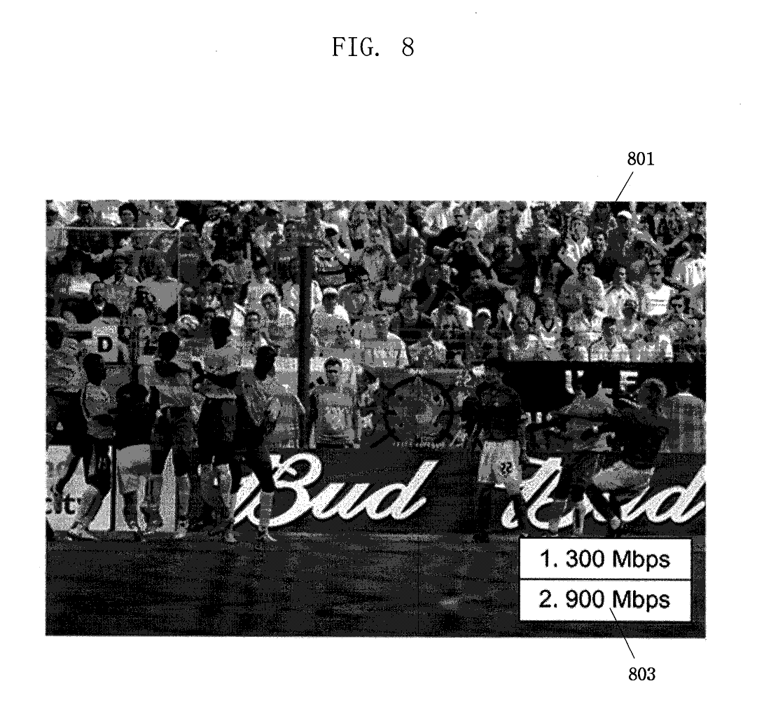

FIG. 9 is a diagram illustrating a LASeR scene description scene outputted according to the sentences shown in FIG. 7.

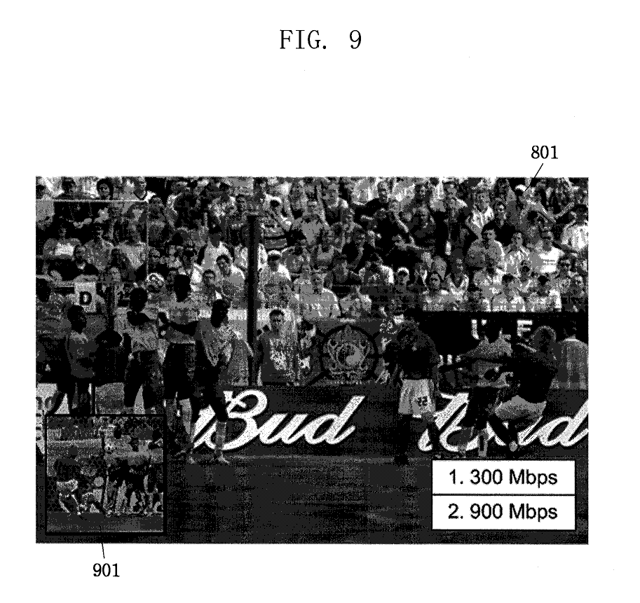

FIG. 10 is a block diagram illustrating DIDL structure in accordance with an embodiment of the present invention.

FIG. 11 is a diagram illustrating exemplary sentences of DIDL in accordance with an embodiment of the present invention.

FIG. 12 is a diagram illustrating exemplary sentences of DIDL in accordance with an embodiment of the present invention.

FIG. 13 is a block diagram illustrating MPEG-21 based DI processing apparatus in accordance with an embodiment of the present invention.

### BEST MODE FOR THE INVENTION

The advantages, features and aspects of the invention will become apparent from the following description of the embodiments with reference to the accompanying drawings, which is set forth hereinafter.

According to an embodiment of the present invention, the digital item declaration of MEPG-21 standard includes scene representation information using a scene representation language such as LASeR that defines the spatio-temporal relations of media components and expresses a scene of multimedia contents in a form allowing the media components to interact. Also, the digital item base operation (DIBO) of the digital item processing (DIP) includes a scene representation call function. Such a configuration of the present invention allows MPEG-21 digital items to be consistently consumed using a scene representation language, for example, LASeR.

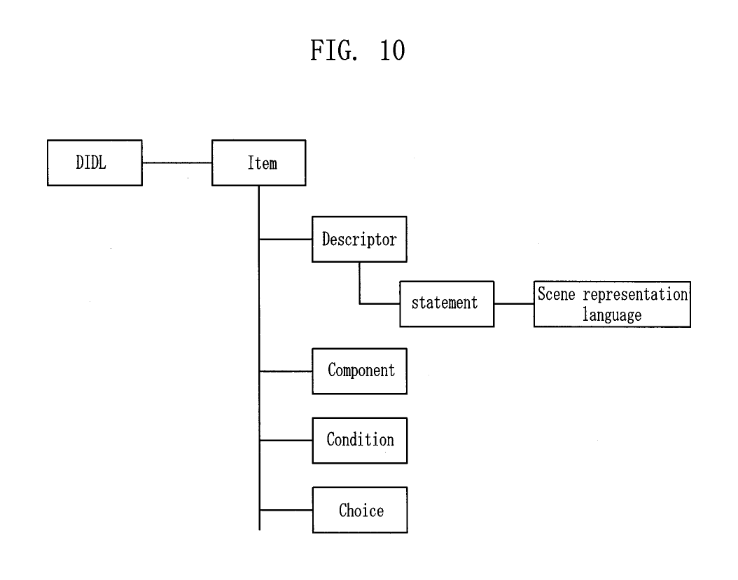

FIG. 10 is a diagram illustrating the structure of a digital item description language (DIDL) in accordance with an embodiment of the present invention. FIG. 10 shows the location of the scene representation in a DIDL structure.

As shown in FIG. 10, the DIDL includes an Item node that represents a digital item. The Item node includes nodes that describe and define a digital item (DI) such as Descriptor, Component, Condition, and Choice. Such a DIDL structure is defined in the MPEG-21 standard. The MPEG-21 standard may be used as a part of the present specification if the description of the DIDL structure is necessary.

In the DIDL structure, Statement component that is a lower node of the Description node may include various types of machine readable formats such as a plain text and an XML.

In the present embodiment, Statement component may include LASeR or XMT scene representation information without modifying the current DIDL specification.

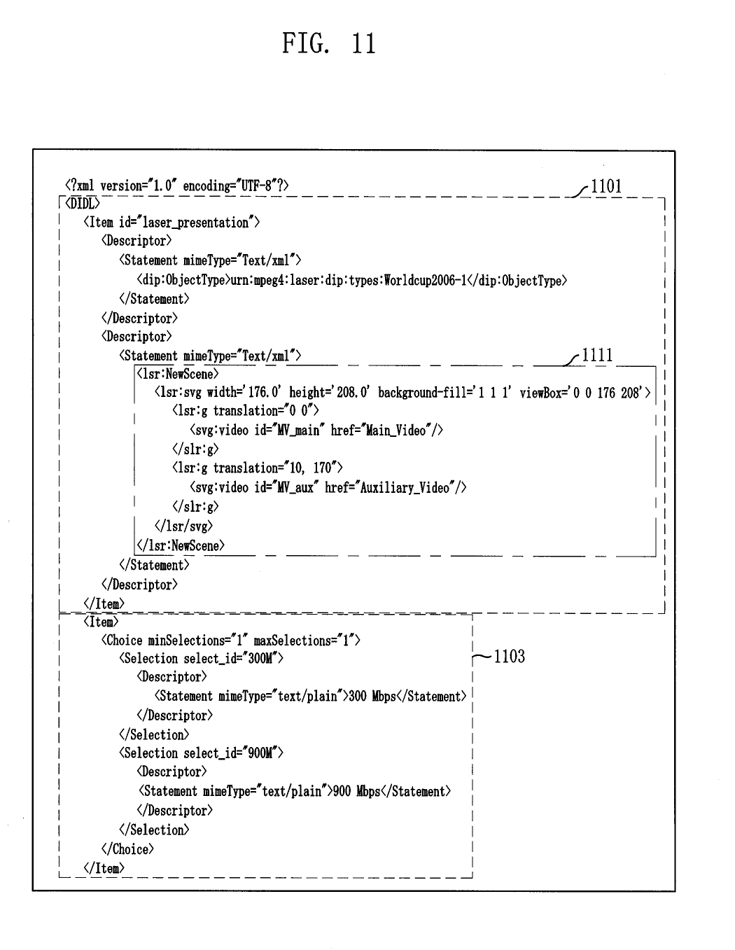

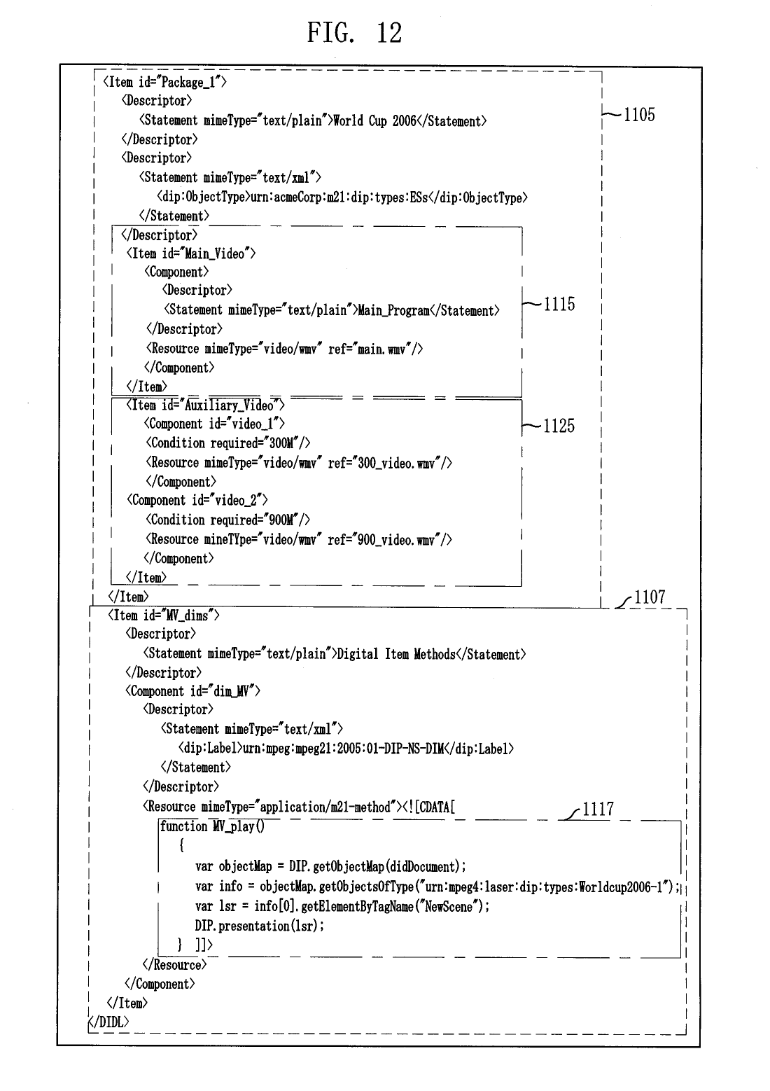

FIGS. 11 and 12 show exemplary sentences of DIDL in accordance with an embodiment of the present invention.

As shown in FIGS. 11 and 12, the DIDL is constituted of four items 1101, 1103, 1105, and 1107. The third item 1105 is constituted of two items 1115 and 1125.

The third item 1105 defines the formats and resources of the item 1115 having Main_Video as an ID and the item 1125 having Auxiliary_Video as an ID.

The first item 1101 includes LASeR scene representation information 1111 as a lower node of Statement node. As shown in FIG. 11, the LASeR scene representation information 1111 represents a spatial scene for two media components Main Video and Auxiliary_Video, which are defined in items 1115 and 1125.

In the exemplary sentences of FIGS. 11 and 12, a Main_Video media component MV_main is displayed on the location moved from the origin of display as far as (0,0), and a MV_aux is displayed on the location moved from the origin of display as far as (10, 170). That is, the Main_Video is displayed at the origin of display, and the Auxiliary_video is displayed at the location separated from the origin of display as far as 10 pixels in a right direction and 170 pixels in a downward direction.

Since MV_main is displayed at first and the MV_aux is displayed later, it is described that the MV_main is executed first then the MV_aux is executed in a time domain. Therefore, the MV_main does not cover the MV_aux because the MV_main is comparatively larger than the MV_aux.

According to the present embodiment, a DI author is enabled to describe the various media resources of a desired digital item in the scene representation information 1111 to define a spatio-temporal relation of the various media resources and to express a scene in a form that allows the various media resources to interact. Therefore, the spatio-temporal relation can be defined by integrating various media resources of MPEG-21 digital item to one multimedia content and a scene can be expressed in a form allowing the various media resources to interact.

The second item 1103 of the DIDL in FIGS. 11 and 12 is defined to select one of 300 Mbps and 900 Mbps. That is, one of 300 Mbps video_1 and 900 Mbps video_2 is decided as the Auxiliary_Video according to the selection provided from the second item 1103 for the Auxiliary_Video, and the selected resource (300_video.wmv or 900_video.wmv) is provided.

The fourth item 1107 of a DIDL sentence shown in FIGS. 11 and 12 is an item that defines a digital item method (DIM). That is, the fourth item 1107 defines a presentation function that calls LASeR scene representation information 1111.

Hereinafter, the presentation function shown in FIGS. 11 and 12 will be described.

Table 1 shows the presentation function included in the fourth item 1107 of FIG. 12 as a function calling LASeR scene representation 1111 of FIG. 11 which is scene representation information using the scene representation language, LASeR.

TABLE 1

| | |
|---|---|
| Function | presentation (element) |
| Description | Present a specified scene representation |
| Parameter | element: |
| | A document object model (DOM) Element |
| | object representing the root element of the |
| | scene representation to be presented. |
| Return value | A Boolean value of true if the scene was |
| | successfully presented or false if the |
| | scene was failed to be presented. |
| Exeption | DIPError |

As shown in Table 1, the scene representation information included in DIDL sentences, for example, the LASeR scene representation information 1111 of FIG. 11, is processed using a digital item base operation (DIBO) of a digital item declaration (DID). That is, the presentation( ) function of Table 1 defined as the DIBO of digital item processing (DIP) is called and the scene representation information 1111 is analyzed and expressed from the DID.

A scene representation engine expresses the scene representation information 1111, which is called by the presentation( ) function, to define a spatio-temporal relation of various media resources of a DI and to express a scene in a form allowing the various media resources to interact.

The parameter of the presentation( ) function is a document object model (DOM) element object that denotes the root element of the scene representation information 1111. For example, the parameter denotes <lsr:NewScene> element of the scene representation information 1111 in FIG. 11.

The scene representation information 1111 is called by [DIP.preserntation(lsr)] included in the fourth item 1107 of FIG. 12 and used as scene configuration information.

As a return value, the presentation( ) function returns a Boolean value “true” if the scene representation engine successes to present the scene based on the called scene representation information 1111 or returns a Boolean value “false” if the scene representation engine fails to present the scene.

If the parameter of the presentation( ) function is not the root element of the scene representation information 1111 or if the error generated in the course to present the scene, the presentation( ) function may return an error code. For example, the error code may be INVALID_PARAMETER if the parameter of the representation( ) function is not thte root element of the scene representation information 1111. Also, the error code may be PRESENT_FAILED if an error is generated in the course to present the scene.

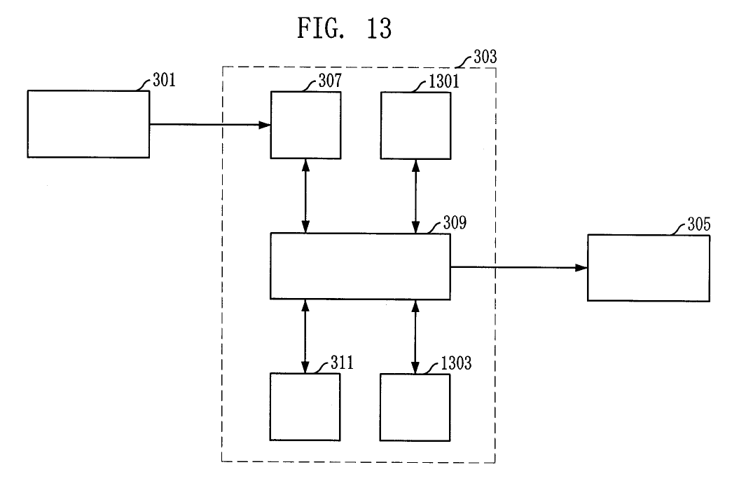

FIG. 13 is a block diagram illustrating a MPEG-21 based DI processing system in accordance with an embodiment of the present invention.

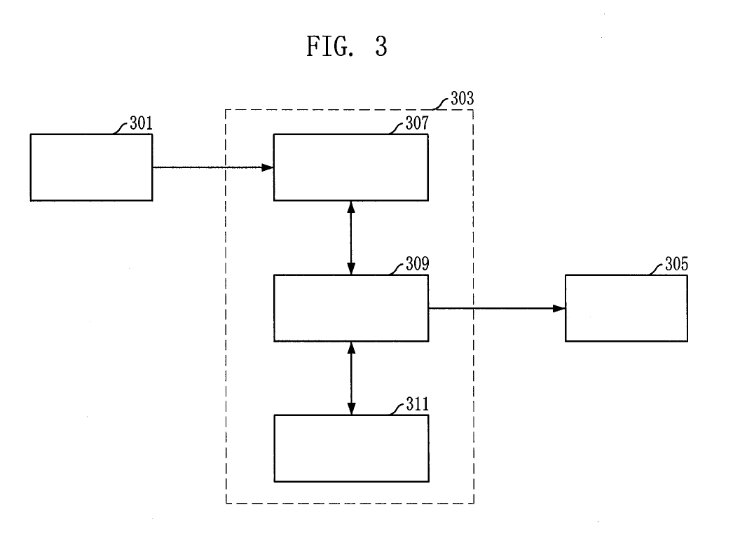

The MPEG-21 based DI processing system according to the present embodiment has following differences compared with the system according to the related art shown in FIG. 3.

As the first difference, DIDL that expresses a digital item inputted to a DI input means 301 includes scene representation information and a call function according to the present embodiment.

As the second difference, a DI process engine unit 307 includes a scene representation engine 1301 that presents a scene according to scene representation information 1111 in the present embodiment. The scene representation engine 1301 is an application for analyzing and processing a scene representation included in DIDL, for example, LASeR. The scene representation engine 1301 is driven by a scene representation base operator 1303 according to the present embodiment.

As the third difference, the scene representation base operator 1303 is included in DI base operation unit 311 by defining the calling function presentation( ) in the present embodiment.

As described above, the scene representation engine is executed through the scene representation base operation unit 1303 by calling scene representation information included in DIDL. Then, the scene representation engine 1301 defines a spatio-temporal relation of MPEG-21 digital items and expresses a scene of multimedia contents in a form that allows the MPEG-21 digital items to interact in the present embodiment, thereby outputting the MPEG-21 digital items through the DI output unit 305. Therefore, MPEG-21 digital items can be provided to a user as a form that defines spatio-temporal relations in a consistent manner and allows MPEG-21 digital items to interact.

As shown in FIG. 13, a DI including a plural of DIMs inputs through the DI input means 301. The DI process engine unit 307 parses the inputted DI, and the parsed DI is inputted to the DI express unit 309.

Then, the DI express unit 309 processes a digital item by executing a DI process engine of the DI process engine unit 307 through a digital item base operation (DIBO) included in the DI base operation unit 311 based on an item including a function calling scene representation information included in a DIDL representing a DI a function, for example, MV_play( ) 1117 of FIG. 12.

Here, the DI express unit 309 expresses a scene of multimedia contents in a form that defines a spatio-temporal relation of digital items and allows digital items to interact according to scene representation included in DIDL by executing a scene expression engine 1301 through a scene expression base operator 1303 based on a function calling scene representation included in DIDL expressing a DI.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

While the present invention has been described with respect to certain preferred embodiments, it will be apparent to those skilled in the art that various changes and modifications may be made without departing from the spirits and scope of the invention as defined in the following claims.

### INDUSTRIAL APPLICABILITY

A digital item description and process apparatus for presenting a scene of multimedia contents in a form of defining spatio-temporal relations of MPEG-21 digital items and allowing MPEG-21 digital items to interact, and a method thereof are provided.

What is claimed is:

1. A digital item processing apparatus for processing a digital item expressed as a digital item declaration language (DIDL) of MPEG-21, comprising:
a digital item method engine (DIME) means for executing items based on component information included in the digital item; and
a scene representation means for presenting a scene of a plural number of media data included in the digital item in a form of defining spatio-temporal relations and allowing the media data to interact with each other,
wherein the digital item includes scene representation information having representation information of the scene, and calling information for the digital item express means to execute the scene representation means in order to present the scene based on the scene representation information at the scene representation means.

2. The digital item processing apparatus of claim 1, wherein the scene representation means includes:
a scene representation engine unit for representing the scene based on the scene representation information; and
a digital item base operation (DIBO) unit for executing the scene representation means according to the control of the digital item representation means based on the calling information.

3. The digital item processing apparatus of claim 1, wherein the scene representation information is expressed using one of Synchronized Multimedia Integration Language (SMIL), Scalable Vector Graphics (SVG), eXtensible MPEG-4 Textual Format (XMT), and Lightweight Applications Scene Representation (LASeR).

4. The digital item processing apparatus of claim 1, wherein the scene representation information is included in Statement component that is a lower node of Description node in DIDL.

5. A digital item processing apparatus for processing a digital item, comprising:
a digital item express means for executing items based on component information included in the digital item; and
a scene representation means for presenting a scene of a plural of media data included in the digital item a form of defining spatio-temporal relations and allowing the media data to interact with each other,
wherein the digital item includes scene representation information including the representation information of the scene and calling information for executing the scene representation means by the digital item express means for representing the scene based on the scene representation information at the scene representation means.

6. The digital item processing apparatus of claim 5, wherein the scene representation means includes:
a scene representation engine unit for expressing the scene based on the scene representation information; and
a scene representation base operation unit for executing the scene representation means according to control of the digital item express means based on the calling information.

7. The digital item processing apparatus of claim 5, wherein the digital item is expressed as a digital item declaration language (DIDL) of MPEG-21 standard.

8. The digital item processing apparatus of claim 5, wherein the scene representation information is expressed by one of Synchronized Multimedia Integration Language (SMIL), Scalable Vector Graphics (SVG), extensible MPEG-4 Textual Format (XMT), and Lightweight Applications Scene Representation (LASeR).

9. The digital item processing apparatus of claim 5, wherein the digital item express means is a digital item method engine (DIME) of MPEG-21 standard.

10. The digital item processing apparatus of claim 5, wherein the scene representation base operation unit is a digital item base operation (DIBO) of MPEG-21 standard.

11. A method for processing a digital item described as a digital item declaration language (DIDL) of MPEG-21 standard, comprising the steps of:
executing components based on component information is included in the digital item by digital item method engine (DIME); and
expressing a scene of a plural number of media data included in the digital item in a form of defining spatio-temporal relations and allowing the media data to interact with each other,
wherein the digital item includes scene representation information having representation information of the scene, and calling information to perform the step of expressing the scene of a plural number of media data in order to represent the scene based on the scene representation information.

12. The method of claim 11, wherein the scene representation information is expressed by one of Synchronized Multimedia Integration Language (SMIL), Scalable Vector Graphics (SVG), extensible MPEG-4 Textual Format (XMT), and Lightweight Applications Scene Representation (LASeR).

13. The method of claim 11, wherein the scene representation information is included in Statement component that is a lower node of Descriptor node in DIDL.

14. A method for processing a digital item, comprising the steps of:
executing components based on component information included in the digital item; and
expressing a scene of a plural number of media data included in the digital item in a form of defining spatio-temporal relations and allowing the media data to interact with each other,
wherein the digital item includes scene representation information having representation information of the scene, and calling information to perform the step of expressing the scene of a plural of media data in order to represent the scene based on the scene representation information.

15. The method of claim 14, wherein the digital item is expressed by digital item declaration language (DIDL) of MPEG-21 standard.

16. The method of claim 14, wherein the scene representation information is expressed by one of Synchronized Multimedia Integration Language (SMIL), Scalable Vector Graphics (SVG), extensible MPEG-4 Textual Format (XMT), and Lightweight Applications Scene Representation (LASeR).

17. The method of claim 14, wherein the step of executing components is performed by digital item method engine (DIME) of MPEG-21 standard.
